(19) United States
(12) Patent Application Publication
(10) Pub. No.: US 2014/0095738 A1
(43) Pub. Date: Apr. 3, 2014

(54) DEVICE AND METHOD FOR SUPPORTING EXTERNAL DEVICE I/O USING MOBILE COMMUNICATION TERMINAL

(71) Applicant: Electronics and Telecommunications Research Institute, Daejeon (KR)

(72) Inventors: Ju-Wan KIM, Daejeon (KR); Yun-Kyung PARK, Daejeon (KR); Chae-Kyu KIM, Daejeon (KR)

(73) Assignee: Electronics and Telecommunications Research Institute, Daejeon (KR)

(21) Appl. No.: 13/944,433

(22) Filed: Jul. 17, 2013

(30) Foreign Application Priority Data
Sep. 28, 2012 (KR) 10-2012-0109403

(51) Int. Cl. G06F 13/10

(52) U.S. Cl. CPC G06F 13/102
USPC 710/8

(57) ABSTRACT

There are provided a device and method for supporting an external device I/O using a mobile communication terminal that the mobile communication terminal held by an individual may be used as an I/O unit of the external device, which is driven by the external device, for example, a kiosk and a digital signage, rather than driven by the mobile communication terminal. Further, a plurality of users may simultaneously perform I/O of the external device using each of the mobile communication terminals held by the plurality of users.

### CROSS-REFERENCE TO RELATED APPLICATION

This application claims the benefit under 35 U.S.C. §119(a) of a Korean Patent Application No. 10-2012-0109403, filed on Sep. 28, 2012, the entire disclosure of which is incorporated herein by reference for all purposes.

### BACKGROUND

1. Field

The following description relates to I/O interface technology, and more particularly, to a device and method for supporting an external device I/O using a mobile communication terminal,

2. Description of the Related Art

In the related art, a touch panel, a keyboard, and a speaker, which are directly connected to a device such as a kiosk or a digital signage, are used as a user I/O unit of, for example, the kiosk and the digital signage. However, it is difficult for two or more users to simultaneously use the I/O unit and it has hygiene issues, for example, bacterial infection, due to sharing by many people.

Korean Unexamined Patent Application Publication No. 10-2012-0079208 (Jul. 12, 2012) proposed a technique in which a mobile communication terminal is used as a user I/O unit of, for example, the kiosk and the digital signage. This technique is a control technique with respect to an external device driven by the mobile communication terminal and it is difficult for a plurality of users to simultaneously use the external device.

Therefore, the inventor studied technology that the mobile communication terminal is used as the I/O unit of the external device, which is driven by the external device, for example, the kiosk and the digital signage, rather than driven by the mobile communication terminal.

### SUMMARY

The following description relates to a device and method for supporting an external device I/O using a mobile communication terminal that the mobile communication terminal may be used as an I/O unit of the external device, which is driven by the external device, for example, a kiosk and a digital signage, rather than driven by the mobile communication terminal.

Moreover, the following description relates to a device and method for supporting an external device I/O using a mobile communication terminal that a plurality of users may simultaneously perform I/O of the external device using each of mobile communication terminals held by the plurality of users.

In one general aspect, a device for supporting an external device I/O using a mobile communication terminal includes a device connecting unit configured to connect the external device and the mobile communication terminal, a profile information acquisition unit configured. to obtain I/O profile information from the mobile communication terminal when the external device and the mobile communication terminal arc connected by the device connecting unit, an I/O environment configuration unit configured to analyze the I/O profile information obtained by the profile information acquisition unit and configure an I/O environment of the mobile communication terminal, an I/O environment driving unit configured to provide the I/O environment configured by the I/O environment configuration unit to the mobile communication. terminal to drive the I/O environ lent, and an I/O processing unit configured to process information input from the mobile communication terminal or information output to the mobile communication terminal through the PO environment driven by the I/O environment driving unit.

The profile information acquisition unit may obtain screen information of the mobile communication terminal and I/O device information supported by the mobile communication terminal as I/O profile information.

The I/O environment configuration unit may configure an I/O interface corresponding to the I/O device information supported by the mobile communication terminal by considering the screen information of the mobile communication terminal as the I/O environment.

An I/O device supported by the mobile communication terminal may be at least one among a touch screen device, a keyboard device, a GPS device, a gyro sensor, acceleration. sensor, a screen device, a vibration sensor, and a speaker.

The device connecting unit may connect the external device and the mobile communication terminal through near field communication.

The I/O environment configuration unit may configure a plurality of I/O environments to simultaneously support I/O of a plurality of mobile communication terminals.

A device for supporting an external device I/O using a mobile communication terminal may further include a mode selecting unit that selects a mode to perform I/O through the mobile communication terminal.

A device for supporting an external device I/O using a mobile communication terminal may further include a device-connection releasing unit that releases a connection between the mobile communication terminal and the external device.

In another aspect, a method of supporting an external device I/O using a mobile communication terminal includes a device connecting step of connecting the external device and the mobile communication terminal; a profile information acquisition step of obtaining, by the external device, I/O profile information from the mobile communication terminal when the external device and the mobile communication terminal are connected in the device connecting step; an I/O environment configuration step of analyzing, by the external device, the I/O profile. information obtained in the profile information acquisition step and configuring I/O environment of the mobile communication terminal; an I/O environment driving step of providing, by the external device, the I/O environment configured in the I/O environment configuration step to the mobile communication terminal and driving the I/O environment; and an I/O processing step of processing, by the external device, information input from the mobile communication terminal or information output to the mobile communication terminal through the I/O environment driven in the I/O environment driving step.

In the profile information acquisition step, the external device may obtain screen information of the mobile communication terminal and I/O device information supported by the mobile communication terminal as the I/O profile information.

In the I/O environment configuration step, the external device may configure an I/O interface corresponding to the 1/O device information supported by the mobile communication terminal by considering the screen information of the mobile communication terminal as the I/O environment.

In the device connecting step, the external device and the mobile communication terminal may be connected through near field communication.

In the I/O environment configuration step, a plurality of I/O environments may be configured to simultaneously support I/O of the plurality of mobile communication terminals.

The method of supporting an external device I/O using a mobile communication terminal may further include a mode selecting step of selecting, by the external device, a mode to perform I/O through the mobile communication terminal.

The method of supporting an external device I/O using a mobile communication terminal may further include a device-connection releasing step of releasing, a connection between the mobile communication terminal and the external device.

Since the present invention uses the mobile communication terminal held by an individual as the I/O unit of the external device, which is driven by the external device, for example, the kiosk and the digital signage, rather than driven by the mobile communication terminal, it is possible to improve user's convenience and has no hygiene issues due to sharing of the I/O unit.

Moreover, since a plurality of users can simultaneously perform I/O of the external device using each of mobile communication terminals held by the plurality of users, it is possible to increase utilization of the external device.

Furthermore, since the invention uses the mobile communication terminal as the I/O unit of the external device, it is possible to decrease a usage frequency of I/O unit equipped in the external device, for example, the kiosk and the digital signage, thereby reducing maintenance costs of the external device.

Other features and aspects will be apparent from the following detailed description, the drawings, and the claims.

### BRIEF DESCRIPTION OF THE DRAWINGS

FIG. 1 is a block diagram illustrating a configuration of a device for supporting an external device I/O using a mobile communication terminal according to an embodiment of the invention.

FIG. 2 is a flowchart illustrating I/O operations of the external device equipped with the device for supporting an external device I/O using a mobile communication terminal according to the embodiment of the invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, in order to facilitate understanding and reproduce by those skilled in the art, the present invention will be described in detail by explaining exemplary embodiments with reference to the accompanying drawings.

When it is determined that detailed explanations of related well-known functions or configurations unnecessarily obscure gist of the embodiments, the detailed description thereof will not be repeated.

The terminology used herein is defined by considering a function in the embodiments, and meanings may vary depending on, for example, a user or operator's intentions or customs. Therefore, the meanings of terms used in the embodiments should be interpreted based on the scope throughout this specification.

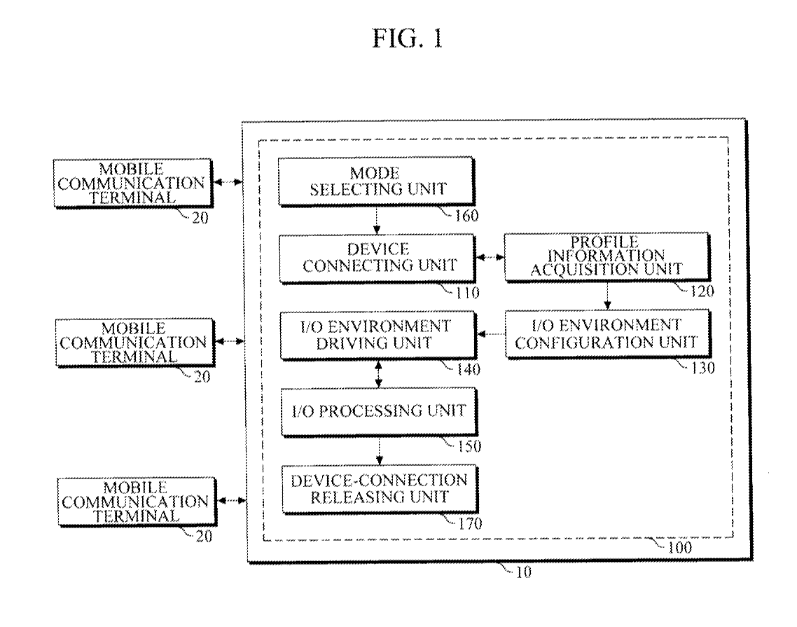

FIG. 1 is a block diagram illustrating a configuration of a device for supporting an external device I/O using a mobile communication terminal according to an embodiment of the invention. A device 100 for supporting an external device I/O using a mobile communication terminal according to the embodiment may be implemented as software, hardware, or a combined type, which is equipped in an external device 10, for example, a kiosk and a digital signage.

As illustrated in FIG. 1, the device 100 for supporting an external device I/O using a mobile communication terminal according to the embodiment includes a device connecting unit 110, a profile information acquisition unit 120, an I/O environment configuration unit 130, an I/O environment driving unit 140, and an I/O processing unit 150.

The device connecting unit 110 connects the external device 10 and a mobile communication terminal 20. For example, the device connecting unit 110 may allow the external device 10 and the mobile communication terminal 20 to be connected through near field communication, for example, Wi-Fi and Bluetooth.

The profile information acquisition unit 120 obtains I/O profile information from the mobile communication terminal 20 when the external device 10 and the mobile communication terminal 20 are connected by the device connecting unit 110.

For example, the profile information acquisition unit 120 may be implemented to obtain screen information of the mobile communication terminal 20 and I/O device information supported by the mobile communication terminal 20 as I/O profile information.

For example, the screen information of the mobile communication terminal 20 may include information about, for example, a size of the screen, and supported resolution. The I/O device information supported by the mobile communication terminal 20 may include information about, for example, a type of an I/O device and a setting value.

For example, the I/O device supported by the mobile communication terminal may be at least one among a touch screen device, a keyboard device, a OPS device, a gyro sensor, an acceleration sensor, a screen device, a vibration sensor, and a speaker.

The I/O environment configuration unit 130 analyzes the I/O profile information obtained by the profile information acquisition unit 120 so as to configure I/O environment of the mobile communication terminal 20. In this case, the I/O environment configured by the I/O environment configuration unit 130 may be an I/O interface that can support contents provided from the external device 10.

For example, when the external device 10 is an ATM device having a type of the kiosk and the contents provided from the external device 10 is financial transaction content including cash deposits and withdrawals, the I/O environment configured by the I/O environment configuration unit 130 may be an I/O interface for the financial transaction.

Meanwhile, the I/O environment configuration unit 130 may be implemented to configure the I/O interface corresponding to the I/O device information supported by the mobile communication terminal 20 by considering screen information of the mobile communication terminal 20 as the I/O environment.

For example, the I/O environment configuration unit 130 may configure a touch screen I/O interface that can be manipulated by the user through the touch screen of the mobile communication terminal 20 with a specific screen resolution of the screen size smaller than that of the mobile communication terminal 20.

Meanwhile, the I/O environment configuration unit 130 may be implemented to configure a plurality of I/O environments so as to simultaneously support I/O of a plurality of mobile communication terminals 20. At this time, each of the plurality of I/O environments may be independently driven by a multitasking method.

The I/O environment driving unit 140 provides the I/O environment configured by the I/O environment configuration unit 130 to the mobile communication terminal 20 to drive it. The user performs an external device I/O through the I/O environment that is provided from the I/O environment driving unit 140 to the mobile communication terminal 20 to drive it.

The I/O processing unit 150 processes information input from the mobile communication. terminal 20 or information output to the mobile communication terminal 20 through the environment driven by the I/O environment driving unit 140.

That is, the I/O processing unit 150 receives information input from the mobile communication terminal 20 through the I/O environment and processes it as an input of the external device, and processes information output to the mobile communication terminal 20 through the I/O environment and outputs it to the mobile communication terminal 20,

Accordingly, since the present invention uses the mobile communication terminal held by an individual as the I/O unit of the external device, for example, the kiosk and the digital signage, it is possible to improve user's convenience and has no hygiene issues due to sharing of the I/O unit of the external device.

Moreover, since a plurality of users can simultaneously perform I/O of the external device using each of mobile communication terminals held by the plurality of users, it is possible to increase utilization of the external device.

Furthermore, since the invention uses the mobile communication terminal as the I/O unit of the external device, it is possible to decrease a usage frequency of I/O unit equipped in the external device, for example, the kiosk and the digital signage, thereby reducing maintenance costs of the external device.

Meanwhile, in another aspect, the device 100 for supporting an external device I/O using a mobile communication terminal may further include a mode selecting unit 160. The mode selecting unit 160 selects a mode to perform I/O through the mobile communication terminal 20.

The external device 10 may perform I/O through the I/O device (not illustrated) installed therein and may also perform I/O through the mobile communication terminal 20.

In the embodiment, a mode to perform I/O through the mobile communication terminal 20 is selected by the mode selecting unit 160 so that I/O is performed by the I/O device (not illustrated) installed therein and also performed by the mobile communication terminal 20.

For example, when the mobile communication terminal 20 is not present in a predetermined distance from the external device, the mode selecting unit 160 may cause to operate in a mode in which I/O is performed through the I/O device (not illustrated) installed in the external device 10, and when the mobile communication terminal 20 is present in the predetermined distance from the external device, the mode selecting unit 160 may cause to activate a mode in which I/O is performed through the mobile communication terminal 20 in order to simultaneously use two modes.

Meanwhile, in another aspect, the device 100 for supporting an external device I/O using a mobile communication terminal may further include a device-connection releasing unit 170. The device-connection releasing unit 170 releases a connection between the mobile communication terminal 20 and the external device 10.

That is, the device-connection releasing unit 170 releases the connection between the mobile communication terminal 20 and the external device 10 when the external device I/O through the mobile communication terminal 20 is completed. For example, the device-connection releasing unit 170 disconnects the near field communication between mobile communication terminal 20 and the external device 10 so that the connection between the mobile communication terminal 20 and the external device 10 may be released.

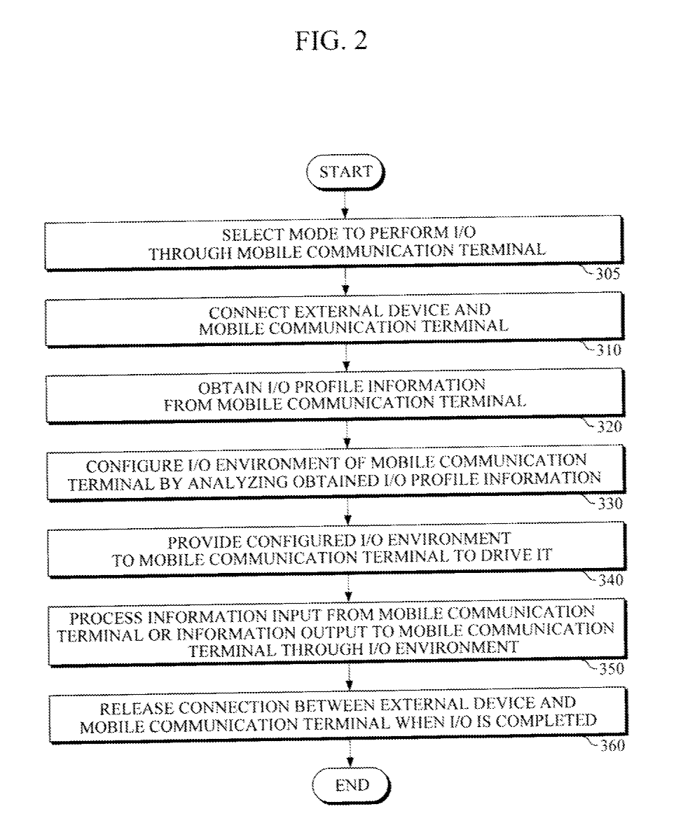

As described above, I/O supporting operations of the device for supporting an external device I/O using a mobile communication terminal according to the invention will be described with reference to FIG. 2. FIG. 2 is a flowchart illustrating I/O operations of the external device equipped with the device for supporting an external device I/O using a mobile communication terminal according to the embodiment of the invention.

First, in a device connecting operation 310, the external device equipped with the device for supporting an external device I/O using a mobile communication terminal according to the invention connects the external device and the mobile communication terminal. For example, in the device connecting operation 310, the external device and the mobile communication terminal may be connected through near field communication, for example, Wi-Fi and Bluetooth.

When the external device and the mobile communication terminal are connected in the device connecting operation 310, the external device obtains I/O profile information from the mobile communication terminal in a profile information acquisition operation 320.

For example, it may be implemented such that the external device obtains screen information of the mobile communication terminal and I/O device information supported by the mobile communication terminal as the I/O profile information in the profile information acquisition operation 320.

For example, the screen information of the mobile communication terminal may include information about, for example, a size of the screen and supported resolution. The I/O device information supported by the mobile communication terminal may include information about, for example, a type of an I/O device and a setting value.

For example, the I/O device supported by the mobile communication terminal may be at least. one among a touch screen device, a keyboard device, a GPS device, a gyro sensor, an acceleration sensor, a screen device, a vibration sensor, and a speaker.

Next, in an I/O environment configuration operation 330, the external device analyzes the I/O profile information obtained by the profile information acquisition operation 320 so as to configure I/O environment of the mobile communication terminal. In this case, the I/O environment configured by the I/O environment configuration operation 330 may be an I/O interface that can support contents provided from the external device.

Meanwhile, in the I/O environment configuration operation 330, the external device may cause to configure the I/O interface corresponding to the I/O device information supported by the mobile communication terminal by considering screen information of the mobile communication terminal as the I/O environment.

Meanwhile, in the I/O environment configuration operation 330, the external device may cause to configure a plurality of I/O environments so as to simultaneously support I/O of a plurality of mobile communication terminals. At this time, each of the plurality of I/O environments may be independently driven by a multitasking method.

Next, in an I/O environment driving operation 340, the external device provides the I/O. environment configured by the I/O environment configuration operation 330 to the mobile communication terminal to drive it. The user performs an external device I/O through the I/O environment that is provided by the ho environment driving operation 340 to the mobile communication terminal to drive it.

In an I/O processing operation 350, the external device processes information input from the mobile communication terminal or information output to the mobile communication terminal through the I/O environment driven by the I/O environment driving operation 340.

That is, in the I/O processing operation 350. the external device receives information input from the mobile communication terminal through the I/O environment and processes it as an input of the external device, and processes information output to the mobile communication terminal through the I/O environment and outputs it to the mobile communication terminal.

Accordingly, since the present invention uses the mobile communication terminal held by an individual as the I/O unit of the external device, which is driven by the external device, for example, the kiosk and the digital signage, rather than driven by the mobile communication terminal, it is possible to improve user's convenience, and has no hygiene issues due to sharing of the I/O unit.

Moreover, since the plurality of users can simultaneously perform I/O of the external device using each of mobile communication terminals held by the plurality of users, it is possible to increase utilization of the external device.

Furthermore, since the invention uses the mobile communication terminal as the I/O unit of the external device, it is possible to decrease a usage frequency of I/O unit equipped in the external device, for example, the kiosk and the digital signage, thereby reducing maintenance costs of the external device.

Meanwhile, in another aspect, the method of supporting an external device I/O using a mobile communication terminal may further include a mode selecting operation 305. In the mode selecting operation 305, the external device selects a mode to perform I/O through the mobile communication terminal.

The external device may perform I/O through an I/O device installed therein and also perform I/O through the mobile communication terminal. In the embodiment, a mode to perform I/O through the mobile communication terminal is selected by the mode selecting operation 305 so that I/O is performed by the I/O device installed therein and also performed by the mobile communication terminal.

Meanwhile, in another aspect, the method of supporting an external device I/O using a mobile communication terminal may further include a device-connection releasing operation 360. In the device-connection releasing operation 360, the external device releases a connection between the mobile communication terminal and the external device.

For example, in the device-connection releasing operation 360, the external device disconnects the near field communication between the mobile communication terminal and the external device so that the connection between the mobile communication terminal and the o external device may be released when the external device I/O through the mobile communication terminal is completed.

With such a configuration, the present invention uses the mobile communication terminal held by an individual as the I/O unit of the external device, which is driven by the external device, for example, the kiosk and the digital signage, rather than driven by the mobile communication terminal, and accordingly, it is possible to improve user's convenience and has no hygiene issues due to sharing of the I/O unit.

Moreover, since the plurality of users can simultaneously perform I/O of the external device using each of mobile communication terminals held by the plurality of users, it is possible to increase utilization of the external device.

Furthermore, since the invention uses the mobile communication terminal as the I/O unit of the external device, it is possible to decrease a usage frequency of I/O unit equipped in the external device, for example, the kiosk and the digital signage, thereby reducing maintenance costs of the external device. As a result, it is possible to achieve the above-described purposes of the invention.

The present invention can be implemented as a computer-readable code in a computer readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves, such as those used in Internet transmission. In addition, the computer-readable recording medium may be distributed among computer systems over a network such that computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A device for supporting an external device I/O using a mobile communication terminal, comprising:
a device connecting unit configured to connect the external device and the mobile communication terminal;
a profile information acquisition unit configured to obtain I/O profile information from the mobile communication terminal when the external device and the mobile communication terminal are connected by the device connecting unit;
an I/O environment configuration unit configured to analyze the I/O profile information obtained by the profile information acquisition unit and configure an I/O environment of the mobile communication terminal;
an I/O environment driving unit configured to provide the I/O environment configured by the I/O environment configuration unit to the mobile communication terminal to drive the I/O environment; and
an I/O processing unit configured to process information input from the mobile communication terminal or information output to the mobile communication terminal through the I/O environment driven by the I/O environment driving unit.

2. The device for supporting an external device I/O using a mobile communication terminal according to claim 1, wherein the profile information acquisition unit obtains screen information of the mobile communication terminal and I/O device information supported by the mobile communication terminal as the I/O profile information.

3. The device for supporting an external device I/O using a mobile communication terminal according to claim 2, wherein the I/O environment configuration unit configures an I/O interface corresponding to the I/O device information supported by the mobile communication terminal by considering the screen information of the mobile communication terminal as the I/O environment.

4. The device for supporting an external device I/O using a mobile communication terminal according to claim 2, wherein the I/O device supported by the mobile communication terminal includes at least one among a touch screen device, a keyboard device, a GPS device, a gyro sensor, an acceleration sensor, a screen device, a vibration sensor, and a speaker.

5. The device for supporting an external device I/O using a mobile communication terminal according to claim 1, wherein the device connecting unit connects the external device and the mobile communication terminal through near field communication.

6. The device for supporting an external device I/O using a mobile communication terminal according to claim 1, wherein the I/O environment configuration unit configures a plurality of I/O environments to simultaneously support I/O of a plurality of mobile communication terminals.

7. The device for supporting an external device I/O using a mobile communication terminal according to claim 1, further comprising a mode selecting unit that selects a mode to perform I/O through the mobile communication terminal.

8. The device for supporting an external device I/O using a mobile communication terminal according to claim 1. further comprising a device-connection releasing unit that releases a connection between the mobile communication terminal and the external device.

9. A method of supporting an external device I/O using a mobile communication terminal, the method comprising:
a device connecting step of connecting the external device and the mobile communication terminal;
a profile information acquisition step of obtaining, by the external device, I/O profile information from the mobile communication terminal when the external device and the mobile communication terminal are connected in the device connecting step;
an I/O environment configuration step of analyzing, by the external device, the I/O profile information obtained in the profile information acquisition step and configuring I/O environment of the mobile communication terminal;
an I/O environment driving step of providing, by the external device, the I/O environment configured in the I/O environment configuration step to the mobile communication terminal and driving the I/O environment; and
an I/O processing step of processing, by the external device, information input from the mobile communication terminal or information output to the mobile communication terminal through the I/O environment driven in the I/O environment driving step.

10. The method of supporting an external device I/O using a mobile communication terminal according to claim 9, wherein, in the profile information acquisition step, the external device obtains screen information of the mobile communication terminal and I/O device information supported by the mobile communication terminal as the I/O profile information.

11. The method of supporting an external device I/O using a mobile communication terminal according to claim 10, wherein, in the I/O environment configuration step, the external device configures an I/O interface corresponding to the I/O device information supported by the mobile communication terminal by considering the screen information of the mobile communication terminal as the I/O environment.

12. The method of supporting an external device I/O using a mobile communication terminal according to claim 10, wherein the I/O device supported by the mobile communication terminal includes at least one among a touch screen device, a keyboard device, a UPS device, a gyro sensor, an acceleration sensor, a screen device, a vibration sensor, and a speaker.

13. The method of supporting an external device I/O using a mobile communication terminal according to claim 9, wherein, in the device connecting step, the external device and the mobile communication terminal are connected through near field communication.

14. The method of supporting an external device I/O using a mobile communication terminal according to claim 9, wherein, in the I/O environment configuration step, a plurality of I/O environments are configured to simultaneously support I/O of a plurality of mobile communication terminals.

15. The method of supporting an external device I/O using a mobile communication terminal according to claim 9, further comprising a mode selecting step of selecting, by the external device, a mode to perform I/O through the mobile communication terminal.

16. The method of supporting an external device I/O using a mobile communication terminal according to claim 9, further comprising a device-connection releasing step of releasing a connection between the mobile communication terminal and the external device.
